(19) United States
(12) Patent Application Publication
(10) Pub. No.: US 2010/0054518 A1
(43) Pub. Date: Mar. 4, 2010

(54) Head mounted voice communication device with motion control

(76) Inventor: Alexander Goldin, Haifa (IL)

Correspondence Address: Pearl Cohen Zedek Latzer, LLP, 1500 Broadway, 12th Floor, New York, NY, 10036, US

(21) Appl. No.: 12/230,798

(22) Filed: Sep. 4, 2008

(51) Int. Cl. H04R 25/00; H04M 1/00

(52) U.S. Cl. 381/370; 455/569.1

(57) ABSTRACT

A hands-free method of controlling a voice communication or music session via a sound terminal by a user employing a headset connected with said terminal. On detecting any of preselected movements, orientations and/or vibrations of the headset, at least one sensor comprised in the headset generates a corresponding signal. This signal is received and processed by a receiving/processing circuit comprised in the headset or in the sound terminal, with transforming said signal to corresponding control data. These control data are sent to the sound terminal, which generates an appropriate command, such as “Accept call”, “Reject call”, “Increase sound volume”, etc. The headset, the sound terminal and a sound system for implementing the method are also disclosed.

### CROSS REFERENCE TO RELATED APPLICATIONS

This application claims benefit of U.S. Provisional Application Ser. No. 60/966,822, filling date Sep. 17, 2007, entitled “Head Mounted Voice Communication Device with Motion Control”.

### 1.1. BACKGROUND OF THE INVENTION

1.2. Field of the Invention

The present invention relates generally to sound systems and in particular to voice communication systems comprising a voice communication terminal, such as a cellular or mobile telephone, and a headset. More particularly, the invention relates to a voice communication system of the described type for providing hands-free functionality.

1.3. Description of the Related Art

Headsets are often used for voice communication and listening music in mobile environments where “hands-free” functionality is required. A typical example is a Bluetooth headset connected wirelessly with a mobile phone or a media player or a radio receiver. Various examples of headsets are described in many published patent documents, among which U.S. Pat. No. 5,793,865; U.S. Pat. No. 6,459,882; U.S. Pat. No. 6,519,475; U.S. Pat. No. 6,810,987; U.S. Pat. No. 7,010,332; U.S. Pat. No. 7,072,686; US 20040198470 and EP1 503 368 may be mentioned. While listening and talking with a headset does not require hands, all other operations such as initiating a call, answering a call, rejecting a call, changing a music track, increasing/decreasing sound volume and the like typically require pressing small buttons on the headset body. This may be inconvenient in some circumstances (e.g. when both hands are occupied) or, sometimes, even dangerous (e.g. while driving a car in dense traffic). It is thus seems useful to provide a headset with hands-free control functionality.

One option to control a headset consists in using automatic speech recognition (ASR) techniques. Indeed, many users prefer to interact with a telephone device via voice commands, particularly in view of the trend in the law towards “hands-free” mobile telephony devices. Examples of ASR techniques are described, among many other publications, in U.S. Pat. No. 6,167,251; U.S. Pat. No. 7,324,942 and EP1 503 368. When employing an ASR system, the user, for example, can say “answer” to start a call, “hand-up” to end a call, “next” to move to a next song, etc. However, speech recognition may be unreliable or inconvenient in noisy conditions, for example in a car with open windows. ASR system may be also prone to false interpretation of input sounds, especially with “noises” produced by other people talking in the vicinity of the headset. Moreover, interpreting voice responses is a challenge for voice-based technology due to different inflections, tones, accents, speech patterns, volumes and many other speech variables. In addition, speech recognition requires constant monitoring of input audio signal which may be in some cases too power consuming for very low power devices such as communication headsets.

Therefore, what is desired is a voice communication and/or entertainment system (which will be termed below as “a sound system”) possessing alternative or additional capabilities for supporting hands-free communication and control and thus providing a greater convenience and comfort for the user.

### BRIEF DESCRIPTION OF THE DRAWINGS

FIG. 1 is a simplified block diagram of the sound system in one exemplary embodiment of the present invention.

FIG. 2 is a simplified block diagram of the sound system in another exemplary embodiment of the present invention.

FIG. 3 is a schematic illustration of generation of exemplary commands by a user supplied with a headset of the present invention.

FIG. 4 shows graphs illustrating generation of exemplary signals in the communication system of the present invention equipped with reference sensors.

FIGS. 5 and 6 are flowcharts illustrating exemplary embodiments of the method of the present invention.

### DETAILED DESCRIPTION OF THE PRESENT INVENTION

The present invention will be further disclosed in the following detailed description of the preferred embodiments with reference to the drawings.

The main idea of the present invention consists in generating control data for controlling communication process between a voice communication terminal of a voice communication system and a headset linked to such terminal with the aid of at least one motion sensor integrated into or mechanically connected to the headset. The same integrated motion sensor or sensors can be used to control the functionality of a portable media player, radio receiver, portable gaming console or another gaming machine as well as other sound reproducing devices or the voice terminal additionally having capabilities of such devices. For simplicity, the detailed description of the invention will pertain to controlling hands-free voice communication. The extension of control capabilities from a voice terminal to sound reproducing devices is clear to persons skilled in the art. Such additional functionality will be mentioned in the description when relevant.

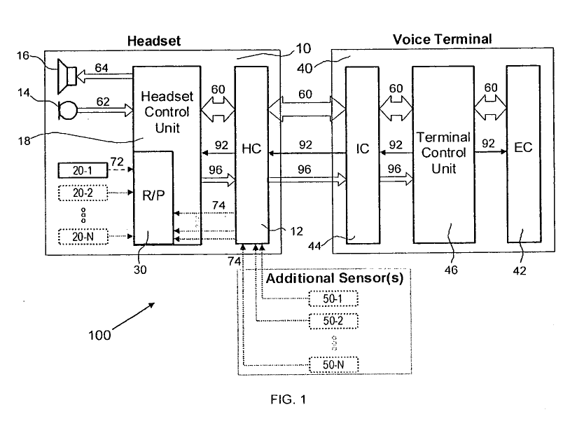

FIG. 1 illustrates the first exemplary embodiment of the voice communication system 100 of the present invention which may be used for hand-free communication in a noisy and/or mobile environment, i. e. in a moving vehicle. The system 100 comprises, as its two main parts, a headset 10 and a voice terminal 40, which are configured as separate (that is distantly located from each other) wirelessly connected units. As shown in FIG. 1, the headset 10 includes a headset communication circuit 12 (also referred to for brevity as the HC circuit) serving primarily for establishing two-way audio communication (indicated by a double-headed arrow 60) with the terminal 40. Such audio communication includes sending to the terminal 40 audio input (indicated by an arrow 62) from a microphone 14 of the headset, as well as receiving audio information from the terminal and sending it as an audio output (indicated by an arrow 64) to an earphone (or a loudspeaker) 16 (though only one earphone is shown in FIG. 1, the headset 10 may comprise two earphones). As will be clear to persons skilled in the art, to ensure receiving and transmitting the above-indicated audio information, the HC circuit 12 may include appropriate audio interface for receiving an audio input from the microphone 14 and for providing an audio output to the earphone(s) 16 and a wireless communications interface providing a wireless communications link with the terminal 40. In case the headset 10 is formed as a Bluetooth headset, the wireless communications link evidently shall be configured as a Bluetooth link.

In case when the terminal is a sound reproducing device or functioning as a sound reproducing device, the communication (indicated by the double-headed-arrow 60) is a one way communication from the terminal 40 to the headset 10. The term “a sound terminal” or just “a terminal” will be applied below for indicating both the voice terminal and various sound reproducing devices (such as various media players, radio receivers, gaming consoles, etc.).

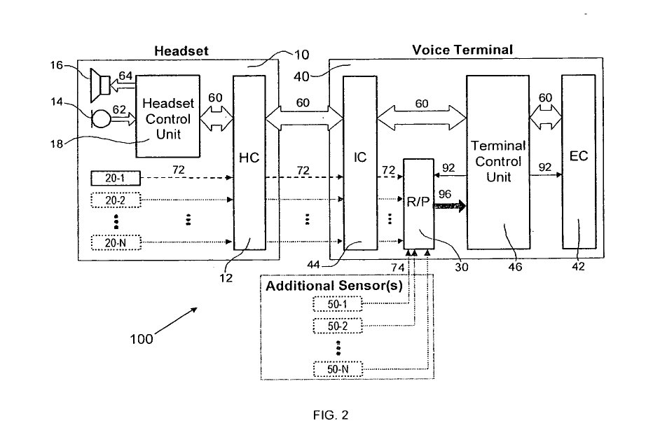

The headset 10 further comprises a headset control unit 18 (for example, in the form of a microcontroller) for controlling performance of various components of the headset 10, including, for example, such control function as switching the headset on/off, adjusting sound volume or a controlling communication link protocol. The control unit 18 is also configured for generating and sending, via the HC circuit 12, control data (indicated by arrows 96) to the sound terminal 40 in order to enable the terminal to execute one or more commands from a preselected set of commands, such as, for example, accepting or rejecting an incoming call, ending a call, playing a next music track or clip, pausing the music, switching to the next radio station, etc. At least some of the control unit's functions are conventionally activated by selectively pressing by the user one or more buttons (not shown in FIGS. 1, 2) conventionally located at the external wall of the headset's body.

The headset 12 further comprises a power source (not shown). Conventionally, the power source is a rechargeable battery. In this case the headset preferably comprises also a socket for a charger. The HC circuit 12 and the power source may be contained in an appropriate enclosure (not shown) attached, together with the earphone 16 and the microphone 14, to an appropriate head mount (not shown). The microphone 14 may be located in a microphone pickup (not shown). Alternatively, both the microphone and the loudspeaker may be located, together with the HC circuit and the power source inside a main body of the headset 10 (not shown). As an alternative, the HC circuit and the power source may be located in different parts of the head mount. As one more alternative corresponding to another conventional headset design, the headset of the present invention may be configured without the head mount, with locating the HC circuit 12 and the power source, together with the earphone, in an appropriately configured earpiece (not shown). Evidently, other mechanical configurations of the headset are also possible.

All the above-mentioned parts and components of the headset 10 may have a conventional design and functionality, well known in the art. Moreover, the specific design and characteristics of the various parts and components comprising the wireless headset 10 are not critical to practicing the present invention, therefore they will not be described or shown in more detail.

Any suitable device supporting interactive (two-way) communications with at least one external communication device and with the headset 10 can be used as the voice communication terminal 40. As an exemplary embodiment of the terminal 40, any mobile (or cell) phone capable to interact with an associated headset may be mentioned. As schematically shown in FIG. 1, the terminal 40 may comprise circuitry common for devices of this type. Such circuitry may include an external communication circuit 42 (also referred to for brevity as the EC circuit) for providing two-way communication with one or more external communication devices (not shown), i.e. with other phones (in case the terminal 40 is the mobile phone). The terminal 40 further comprises an internal communication circuit 44 (also referred to for brevity as the IC circuit) for providing two-way audio communication with the headset 10, that is for sending to said headset audio information received from the external communication device(s) and for receiving audio information from the headset 10.

The terminal 40 also comprises a terminal control unit 46 (for example, in the form of a microcontroller or a microprocessor) for controlling the terminal 40 and the headset 10 by generating and executing appropriate commands from a preselected set of commands and sending such commands to appropriate circuits in the terminal and/or in the headset (sending commands by the terminal control unit 46 is symbolically represented in FIGS. 1, 2 by arrows 92. The set of commands to be generated by the terminal control unit may include such commands as “activate a ringtone in the headset” or “accept an incoming call” and other conventional commands well known in the art.

In one exemplary embodiment the headset 10 and the voice communication terminal 40 may be respectively configured as a Bluetooth headset and a Bluetooth mobile phone. General configuration and functioning of the terminal control units used in the terminals of the above-described type, i.e. in the mobile phones and in Bluetooth mobile phones in particular, are well known in the art. In another exemplary embodiment the headset 10 and the sound terminal 40 may be respectively configured as a Bluetooth stereo headset and a Bluetooth enabled sound reproducing device, e.g. a portable media player. General configuration and functioning of the sound terminal control units used in the terminals of the above-described type are well known in the art.

As will be clear to those skilled in the art, the mobile phone, portable media player or any other appropriate sound reproducing device used as the sound terminal 40 will have other units and/or components necessary for ensuring its functionality, such as an external or internal power source (i.e. batteries), an antenna, etc. The mobile phone acting as the terminal 40 of the voice communication system of the present invention will also comprise a plurality of buttons or keys, a microphone, a loudspeaker, etc. All such parts or components of sound reproducing devices or voice communication terminals in general and mobile phones in particular are not critical to practicing the present invention and, besides, all of them are well known in the art; therefore, for clarity, they are not shown in the drawings and will not be described here. The conventional, well-known in the art functions and operations performed by the sound system, in particular by the voice communication system comprising the voice terminal (such as the Bluetooth mobile phone) and associated headset (such as the Bluetooth headset) also will not be described, for clarity.

Now returning to the headset 10, it further contains (as shown in FIG. 1) N (N≧1) motion/orientation sensors 20. In case of using more than one sensor, such sensors may have similar or different functionality. In general, the sensor(s) purpose is to provide a signal or signals responsive to a change in its (their) location (i.e. to be responsive to a movement or to a change of the orientation of the headset and therefore to a change in a location of the user's head). The sensor or sensors 20 may be based on a variety of technologies. For example, all sensors 20-1, 20-2, . . . 20-N or only one sensor (i.e. the sensor 20-1) may be capable of sensing vibrations of the headset 10. A movement or movements may be detected based on vibration or by sensing acceleration, such as with an accelerometer. As an alternative to the accelerometer, a sensitive gyroscope or a accelerometer/gyroscope combination may be used as any of the sensors 20. Mechanical or liquid-based switches represent alternate mechanisms for sensing movement. In such switches movement causes an electrical connection to be established between contact pairs.

Further, any particular sensor or each sensor 20 may be tuned or configured such that only one stimulus (i.e. only motion in a preselected direction or only a preselected orientation of the head, and so of the headset 10) actuates the sensor. Alternatively, the sensor may be configured to be sensitive to any of two or more different stimuli. In order to minimize a mechanical load on the headset, in some of embodiments of the inventive system it is advantageous to use a single miniature tri-axis accelerometer manufactured using MicroElectroMechanical Systems (MEMS) technology capable to provide all required data on movements of the headset equipped with such accelerometer. As a few non-limiting examples of the sensor suitable for implementing the invention, the following tri-axis MEMS accelerometers may be mentioned: MMA7450L model manufactured by Freescale Semiconductor Inc. (Austin, Tex.); the KXSC7 series manufactured by Kionix (Ithaca, N.Y.); BMA020 model manufactured by Bosch Sensortec GmbH (Reutlingen, Germany); and LIS302DL model manufactured by STMicroelectronics (Geneva, Switzerland).

The single sensor or each sensor 20 is mechanically connected to the headset 10. For example, if the headset 10 comprises the head mount, the sensors may be directly attached to the head mount in different locations thereof. Alternatively, at least one sensor may be attached to the housing of the HC circuit 12. Other versions of mechanically attaching the sensor or sensors to the headset 10 are evidently possible.

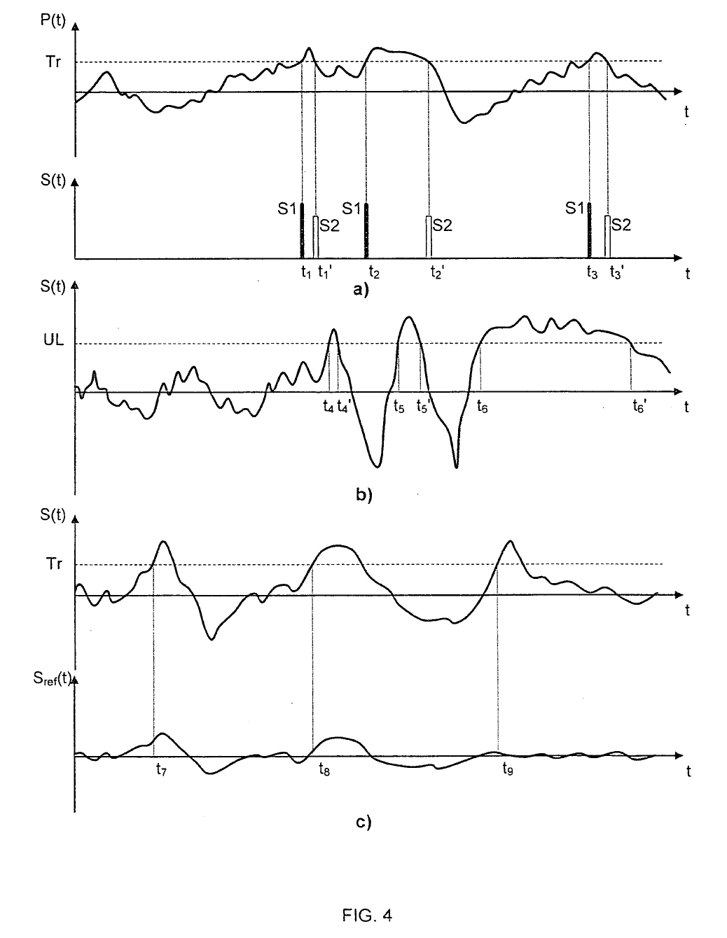

The single or each sensor 20 generates at least one type of headset signals (represented by arrows 72) characterizing at least a position, orientation and/or movement (including vibration) of the headset (or any combination of these parameters, or stimuli). In some embodiments of the headset, when a power consumption issue is not critical, each or some of the sensors 20 may be constantly functioning. However, typically, to save power, the sensors are activated only when the headset control unit 18 receives some control signal or command from the voice communication terminal 40 or directly from the user (who may press for example an appropriate button on the headset). Other ways to minimize periods when the headset signals are generated will be described below with reference to FIGS. 4a, 4b. Evidently, different headset signals may be generated as a result of different movements, positions or orientations of the user's head bearing the headset 10. The headset signals 72 are received by a receiving/processing circuit 30 (which is named below for brevity also as the R/P circuit), said circuit in the embodiment of FIG. 1 forming a part of the headset control unit 18. The receiving/processing circuit 30 may be, for example, a dedicated microcontroller or it may form a part of the microcontroller employed as the control unit. The R/P circuit 30 processes information provided by the sensor(s) 20 in the form of the headset signals and sends resulting control data via the HC circuit 12 to the voice terminal 40. The headset sensors 20 constitute, together with the R/P circuit 30 and the control units 18, 46, the control circuit of the voice communication system 100.

The use of the sensor(s) 20 in performing controlling functions of the voice communication system 100 will be explained below.

FIG. 2 illustrates the second exemplary embodiment of the voice communication system 100 of the present invention. For easy reference, the same reference numerals are used for the same (or similar) parts as those in FIG. 1. As can be seen, the second embodiment is in many respects similar to the first embodiment of the voice communication system shown in FIG. 1, that is it also comprises, as its main parts, the headset 10 and the voice terminal 40, with each of these parts comprising a number of components which are similar or identical to components described in relation to the first embodiment. More specifically, in both the first and the second embodiments the headset 10 comprises the headset communication circuit 12, the microphone 14, the earphone 16 and the sensor(s) 20, as well as such components (not shown in FIGS. 1, 2) as the power source, the head mount, etc., while the terminal 40 comprises the external and internal communication circuits 42, 44 respectively, the control unit 46, as well as such components (not shown in FIGS. 1, 2) as the power source, the antenna, etc. For clarity, as exemplary embodiments of the terminal 40 and the headset 10, the Bluetooth mobile phone and the Bluetooth headset may be selected, though the invention is not limited to such embodiments.

The headset 10 shown in FIG. 2 further comprises N (N≧1) headset sensors 20, said sensors constituting (as was mentioned above with a reference to the embodiment of FIG. 1), together with the R/P circuit 30 and the control units 18, 46, the control circuit of the voice communication system 100. All above-mentioned components, including sensor(s), may have the same or similar configuration and functionality as components of the same type described above with reference to FIG. 1 and therefore do not need any further description, so that only features distinguishing the second embodiment of the system according to the invention from its first embodiment will be described in detail below.

The main difference between both embodiments consists in that in the second embodiment shown in FIG. 2 the R/P circuit 30 is located not in the headset 10, but in the terminal 40, so that the headset signals from the single or several sensors 20 are sent to the HC circuit 12 (as indicated by the arrows 72). The HC circuit 12 sends (optionally after appropriate conditioning) the headset signals 72 via the IC circuit 44 to the R/P circuit 30. In case the system 100 comprises one or more reference sensors 50 (to be described below), such sensor(s) will send their signals 74 to the R/P circuit 30 directly or via the IC circuit 44. As was described above with reference to FIG. 1, the R/P circuit 30 processes the headset signals 72 (optionally conjointly with reference signals 74) and sends resulting control data to the control unit. Though represented in FIG. 2 as a separate unit, the R/P circuit 30 may be alternatively configured as a part of the control unit 46.

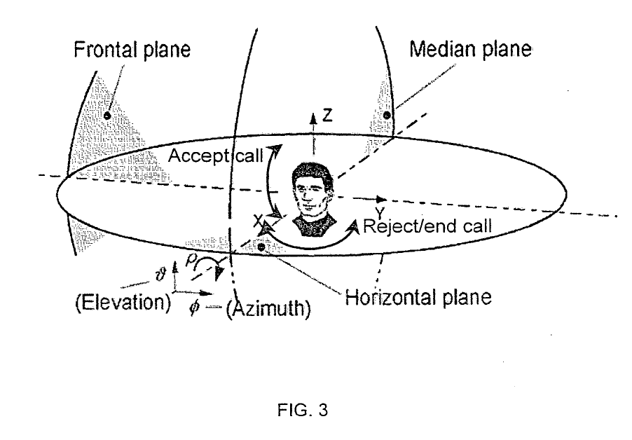

Basic principles of generating various headset signals according to the present invention are illustrated by FIG. 3. As shown in this figure, one kind of the headset signals may correspond to turning (shaking) the head in the horizontal plane (around Z axis). This type of head movements may be assigned, for example, to a decision of the user to reject an incoming call or to end a current call. The headset signals generated by the appropriate sensor(s) 20 are transformed by the R/P circuit 30 into corresponding control data to be sent to the terminal control unit 46 either directly (if the R/P circuit 30 is located in the terminal 40) or via the HC circuit 12 and the IC circuit 44 (if the R/P circuit 30 is located in the headset 10). Having processed the control data corresponding to the headset signals, the terminal control unit 46 generates a command to reject or to end the call and sends this command to the EC circuit 42. Alternatively, a turn of the head (and so of the headset 10) in one direction (i.e. to the left) will result in the command to reject the incoming call, while a similar turn to the opposite direction (i.e. to the right) will result in the command to end the current call.

Turning the head in the median plane (around Y axis) may mean accepting a call. In other words, the headset signals generated by the appropriate sensor 20 when the user is nodding his head, will be eventually transformed into a command (issued by the terminal control unit 46 to the EC circuit 42) to accept an incoming call. Turning the head in the frontal plane (around X axis) may lead to generating by the terminal a command “redial the last dialed number”, while some other command(s) from the preselected set of commands may be generated by appropriate combination(s) of the head movement in the same or different planes.

It is straightforward to persons skilled in the art to translate the corresponding head movements into commands controlling functionality of a portable media player. For example, turning (shaking) the head in the horizontal plane (around Z axis) may be translated into stopping or pausing the music, turning the head in the median plane (around Y axis) may mean starting or resuming the music, turning the head in the frontal plane (around X axis) may lead to generating the command “next track”, etc.

Alternatively or additionally, the sensor 20 (i.e. made as an accelerometer) may detect vibrations caused by user tapping the headset 10. For example:
tapping the headset once may mean “accept an incoming call” or (for sound reproducing devices) “pause/resume the music”;
tapping the headset twice may mean “reject or end a current call” or (for sound reproducing devices) “start/stop the music”;
tapping the headset three times may mean “redial the last dialed number” or (for sound reproducing devices) “next track or radio station”; etc.

In addition, tapping the headset when there is no active or incoming call may serve as a clue for starting speech recognition to dial a certain number.

In some embodiments of the present invention, including those shown in FIGS. 1 and 2, each or some of the sensors 20 may be configured to generate the headset signals not continuously, but only when the stimulus associated with this sensor exceeds a preselected threshold.

In such embodiments a signal generated by the sensor configured in the described way may indicate an attainment of a preselected threshold by a parameter (a stimulus) to which said sensor is made responsive. Possible uses of the sensor configured in this way are illustrated by FIGS. 4a, 4b. As shown by the upper graph in these figures, a parameter P (for example, such as the turning of the headset around Z axis) may change continuously or quasi-continuously with time t, i.e. due to vibrations of a moving vehicle inside of which the voice communication system of the invention is located. In other cases, small movements of the headset may result from involuntary, or unconscious movements of the user's head in course of answering a call or performing some other action. As a result, the headset signal generated by the sensor 20 reacting to the preselected parameter (stimulus) P most of the time may constitute a noise signal. If, however, the sensor is made responsive only when the increasing parameter P attains the preselected threshold Tr, then, as shown by the lower graph in FIG. 4a, the sensor will generate short, well-defined signals S1 only in moments t₁, t₂, t₃ when the movement of head (traced by the sensor) becomes large enough to be presumed to be a voluntary movement employed by the user to control the system 100.

As is further illustrated in FIG. 4a, the sensor may be configured to generate signals also in moments when the threshold Tr is attained by the decreasing parameter P (i.e. in moments t₁′, t₂′, t₃′). While in some embodiments the sensor may generate only one kind of signals S1, in alternative embodiments the sensor may be configured to generate (as illustrated by FIG. 4a) two easily distinguishable kinds of signals, S1 and S2, depending on whether the parameter P is respectively increasing or decreasing. In the latter case, the R/P circuit 30 receiving the signals S(t) will be able to determine from the signals S1 and S2 a time interval during which the parameter P is higher (or lower) than the threshold Tr. Such information may be also useful for discriminating against involuntary movements of the head. Indeed, a time interval for making a certain controlling movement of the user's head may be predetermined, so that information on movements which are too fast (i.e. such movement as performed in the period between t₁ and t₁′) or too slow movements (i.e. such movement as performed in the period between t₂ and t₂′) may be considered by the R/P circuit as non-relevant, even though they correspond to passing the threshold Tr. In this case only the movement of the head performed by the user in the t₃-t₃′ period will result in generating respective control data by the R/P circuit.

Alternatively, the R/P circuit may react to other features of the discrete signals generated by the sensor(s), i.e. to a frequency of their generation or to time intervals between two consecutive signals of the same type. Such approach may be useful when the traced stimulus corresponds to repetitive nodding. If FIG. 4a corresponded to such case, the movement indicated by the signals S1, S2 at moments t₃, t₃′ would be considered as involuntary because it follows the preceding detected movement (covering the time interval between t₂ and t₂′) after too long a pause.

The use of discrete (instead of continuous) sensor signals is advantageous also because both the HC circuit 12 in the headset 10 and the IC circuit 44 in the terminal 40 will work under a lesser load, and a lesser computational power is required in this case from the R/P circuit 30.

FIG. 4b illustrates a situation when there exists a possibility that at some moments (such as moments t₄, t₅, t₆) a parameter P(t) (traced by a sensor) is due to some involuntary movements of the user's head (i.e. resulting from rolling and/or pitching of a ship on board of which the user is located) or from his voluntary movements not intended to be controlling movements (as is the case, for example, when the user bends to pick some object from a floor) may exceed an upper level threshold UL for this parameter established for intentional movements the user performs to make the control unit to generate some command(s). Evidently, generating any commands in such situation would be undesirable. Therefore, the headset signal(s) formed by the sensor(s) preferably are blocked as soon as they exceed(s) UL. In the exemplary situation illustrated by FIG. 4b, blocking the headset signal(s) to the R/P circuit will be stopped at moments (such as moments t₄′, t₅′, t₆′) when said signal(s) will become less than UL.

Returning to FIGS. 1 and 2, in some of its embodiments the voice communication system 100 may further comprise N reference sensors 50 adapted to produce reference signals. Each of the reference sensors 50 preferably is matched to at least one headset sensor 20 mounted to the headset 10. In other words, each sensor of a pair or a group of matched sensors is configured to be responsive to the same type(s) of stimuli (i.e. to a movement or an orientation or a position). Moreover, all mutually matched sensors preferably have the same sensitivity, that is, when reacting to the same stimulus, they generate similar signals. In difference to the headset sensors 20, the reference sensors 50 are mounted not to the headset 10, but to another object moveable in relation to the headset. Considering that the headset 10 itself is moveable (together with the user's head), the expression “an object moveable in relation to the headset” evidently covers also fixed objects, such as walls or a floor of a room (in case the user is located in this room) or a vehicle body (if the user is inside this vehicle). Alternatively, at least one of the reference sensors 50 may be mounted to or located inside the terminal 40. As another alternative, at least one of the reference sensors 50 may be mounted to the user's body.

When one or more reference sensors 50 are used, their signals are also sent to the R/P circuit 30 (as indicated by arrows 74). In this case, the R/P circuit 30, in order to produce control data, will conjointly process the headset signal(s) received from the headset sensor(s) 20 and the reference signal(s) received from the reference sensor(s) 50.

An advantage which may be attained in some embodiments of the system of the invention owing to the use of the reference sensor(s) is illustrated by FIG. 4c representing a situation when the single reference sensor 50 generating a signal S_{ref}(t) is fixed to a belt of the user. It may be seen from FIG. 4c that in the period represented in FIG. 4c the signal S(t) generated by the headset sensor exceeds the threshold Tr three times (at moments t₇, t₈, t₉), so that, in the absence of any reference sensors, the R/P circuit would have three times sent corresponding control data to the terminal control unit 46. However, by comparing the signals S(t) and S_{ref}(t) in short intervals centered around the moments t₇, t₈, t₉, it may be easily determined that movements of the user's head at moments t₇, t₈ were not made by the user with intention to generate a command but were rather involuntary movements of at least a part of his body (including his head and his waist), for example movements resulting from acceleration of the vehicle inside of which the user is located. On the other hand, such comparative analysis will reveal that the head's movement at the moment t₉ was not due to any shifts of the whole body and so may be regarded, with much higher probability, as an intentional movement of the user's head conveying an appropriate command. As will be clear to persons skilled in the art, correlation analysis may be employed to improve reliability of the control data retrieved conjointly from the S(t) signals and the S_{ref}(t) signals.

As was indicated above, in most cases it will be advantageous to employ reference sensor(s) of the same type as the headset sensor(s). For example, if the tri-axis gyroscopes are used for this purpose, in most practical situations it will be enough to employ a single headset sensor and a single reference sensor. As shown in FIG. 4c, such configuration may result in some cases in that S_{ref}(t) signal, on the average, will be substantially less that the S(t) signal (for the reason that the head is much more sensitive to all kinds of external vibrations, accelerations and other disturbances than the other body parts). If needed, such difference in the signals values may be easily compensated by adjusting sensitivity of at least one of the sensors forming a matched pair.

In case the headset sensor 20 and the reference sensor 50 have different orientations, the R/P circuit shall perform, at the beginning of the signals processing, an appropriate transformations of the signals formed by any of the sensors so as to make sensor signals equivalent to signals formed by the sensors having the same orientation. Such transformation may be performed, for example, with the aid of reference signals produced by the gyroscopes used as the headset and reference sensors.

In some embodiments, different types of sensors may be employed. For example, instead of a single reference sensor configured as the tri-axis accelerometer, two or three single-axis accelerometers may be used. The reference sensors may be fixed in the same or in different locations. For example, at least one of such sensors may be mechanically connected to or located in the terminal 40 (evidently, if only one reference sensor is used, it may be placed in various positions depending on convenience of the user or a particular situation).

The above description, with reference to FIGS. 1 to 3, makes it clear that even at least one headset sensor mechanically connected to the headset and coupled to the R/P circuit configured for adequate processing the signals obtained from said at least one headset sensor and for supplying the resulting control data to the control unit of the terminal will expand functionality of the system by hands-free or almost hands-free execution of one or more of selected functions of the system 100 without using voice commands. Further, in many practical situations the additional use of at least a single appropriately configured and located reference sensor may increase effectiveness of discrimination against spurious (involuntary) movements of the user's head and so substantially improve accuracy and/or reliability of the control data sent by the R/P circuit to the terminal control unit.

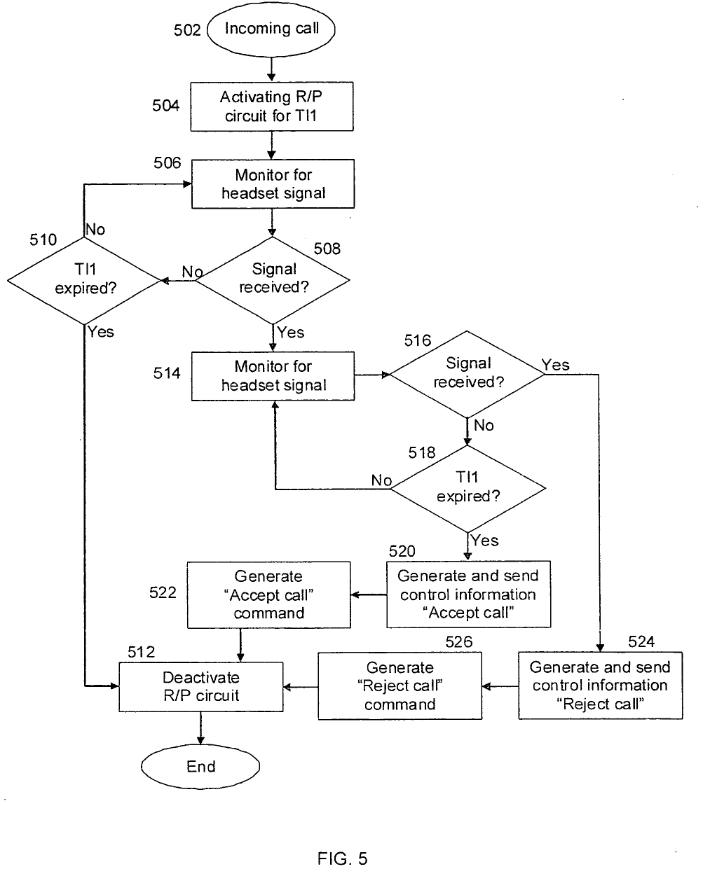

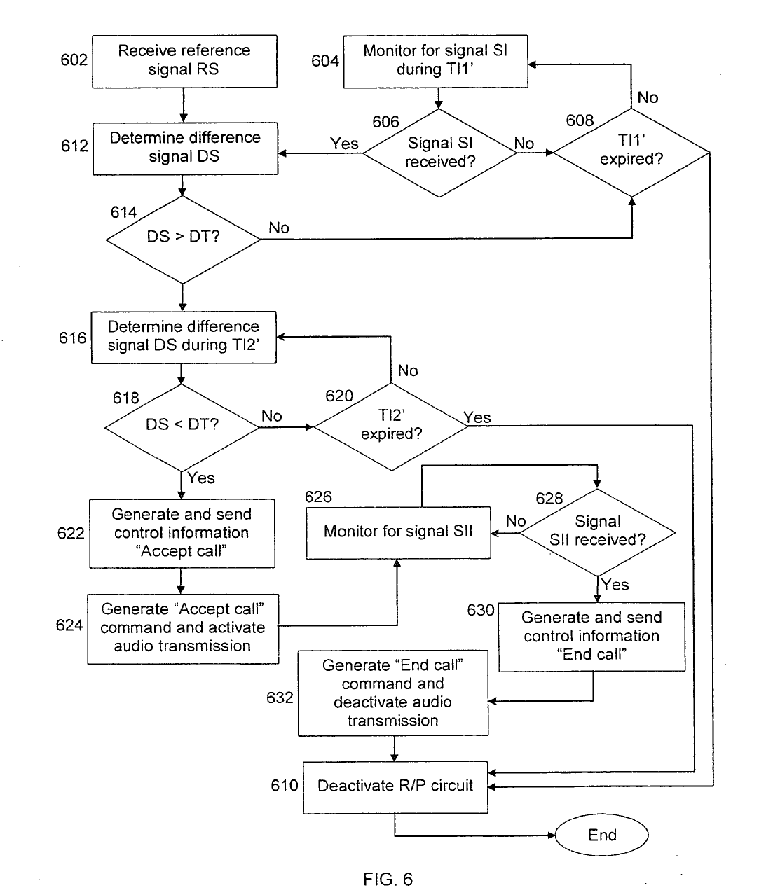

Now exemplary embodiments of the method according to the invention will be described with references to FIGS. 5 and 6.

FIG. 5 depicts a flow chart of an embodiment of the method according to the invention. This embodiment corresponds to a situation when the user may accept an incoming call by a single tap on a Bluetooth communication headset and to reject the incoming call by tapping twice on the headset 10. The headset comprises a single headset sensor 20 in the form of a single-axis (or dual axis or tri-axis) accelerometer connected to the R/P circuit 30 (see FIG. 1). The accelerometer (or another functionally similar sensor) is configured to have a single threshold Tr (the advantage of establishing such threshold have been explained above with reference to FIG. 4a). The voice terminal in this case is a Bluetooth mobile phone.

When the terminal 40 senses, in beginning step 502, an incoming call, it starts sending control signals to the HC circuit 12 telling it that a call is coming. Typically, to save power, no audio signal link is yet activated. The HC circuit informs the user about incoming call by playing tone (via the earphone 16) and/or by initiating a vibration of the headset 10. In some headsets the audio link may be activated to play the ring tone from the phone or to inform the user about the call, e.g. by playing text-to-speech message with the number or calling person name (these actions, being conventional and not critical for the inventive method, are not indicated in FIG. 5). Simultaneously, in step 504, the HC circuit 12 activates the R/P circuit 30 for a predetermined first time interval TI1 allowed for the user to react to the control signals. On activation, the R/P circuit starts monitoring (in step 506) for the headset signal from the headset sensor 20.

Meanwhile the user, being informed of the incoming call, makes one of alternative decisions: to ignore, to accept or to reject the call. In the first case, he does not perform any tapping. As a result, no signals from the headset sensor will be detected in step 508 by the R/P circuit during the first time interval TI1 because any small signals not exceeding the threshold Tr will be will be blocked.

At the end of the first time interval, according to the YES branch of block 510, the R/P circuit is deactivated in step 512, and the incoming call will be considered as “missed”.

In case the user decides to accept the call, he makes a single tap on the headset before the first time interval is over. This tap is transformed by the headset sensor into a relevant headset signal exceeding the threshold Tr, so that this signal will be passed, as indicated by the YES branch of block 508, to the R/P circuit. When the R/P circuit receives the signal, a period of monitoring for the second signal is initiated in step 514, which period corresponds to the second time interval TI2, said second time interval typically being less than the first time interval TI1. When, in step 518, expiration of the second time interval TI2 will be determined, with no signal detected in step 516 during this interval, the R/P circuit generates, in step 520, control data associated with the command “Accept call” and sends said data, via the HC circuit 12 and the IC circuit 44, to the terminal control unit 46. On receiving the control data sent by the R/P circuit, the control unit generates (in step 522) the appropriate command and sends it to the EC circuit, so that the call is accepted.

In case the user decides to reject the call, he makes, in addition to the first tap, the second tap on the headset before the second time interval is over. The sensor reacts to this reference tap by generating the second signal. On receiving this second signal, the R/P circuit generates in step 524 control data associated with the command “Reject call” and sends said data, via the HC circuit 12 and the IC circuit 44, to the terminal control unit 46. On receiving the control data sent by the R/P circuit, the terminal control unit generates (in step 526) the appropriate command and sends it to the EC circuit, so the call is rejected.

It will be evident to persons skilled in the art that, according to the above-described embodiment of the inventive method, the single tap and the double tap on the headset are equivalent to pressing a specific “accept call” or “reject call” button on the headset (or, alternatively, to pressing the same button twice). However, in many situations tapping may be more convenient for the user because it does not require locating a position of a small button, especially in case when the headset comprises more than one button.

Moreover, if a completely hands-free control is preferable, such control may be easily implemented according to other embodiments of the invention using various movements of the user's head as was described above with reference to FIG. 3. One of such embodiments will be described now in more detail with reference to FIG. 6.

FIG. 6 depicts a flow chart of another exemplary embodiment of the method according to the invention. This embodiment corresponds to a situation when the user receives an incoming call while being in a moving vehicle and may accept the call by a single nod, that is by a reciprocal movement of his head in the median (XZ) plane (see FIG. 3). This movement shall begin during a first preselected time interval TI1′ and shall be completed during a second preselected time interval TI2′. Further according to this embodiment, the accepted call is terminated when the user turns his head (that is he performs a reciprocal movement of his head in any direction in the frontal (XY) plane. A Bluetooth communication headset used for implementing this embodiment is similar to that employed for implementing the previous embodiment; however, in this case only a dual axis or tri-axis (but not a single axis) accelerometer may be used as a single headset sensor 20.

The voice communication system 100 in this example further comprises a reference sensor 50 (i.e. a dual axis or tri-axis accelerometer of the same type as the accelerometer used with the headset) located at some other object moveable relative to the user's head (i.e. attached to the voice terminal 40) and operatively connected to the R/P circuit, which, according to the embodiment of the system 100 shown in FIG. 2, may be located in the terminal 40. The terminal 40 in this case also may be a Bluetooth mobile phone. Same as in the previous embodiment, the headset sensor 20 is configured to pass to the R/P circuit (this time not directly but via the HC circuit 12 and the IC circuit 44) only relevant signals, that is signals exceeding the preselected threshold Tr. For clarity, both sensors 20, 50 are presumed to have the same orientation (so that no compensation of a difference in their orientation is necessary), but the reference signals are presumed to be weaker than the headset signals. Accordingly, signals formed by the reference sensor 50 are multiplied (either in the reference sensor circuitry or in the R/P circuit) by a coefficient K exceeding 1. The value of this coefficient is selected depending on a location of the reference sensor and preferably is adjusted experimentally. Such adjustment of the of the multiplication coefficient K will be easily performed by any person skilled in the art.

Initial steps (not represented in FIG. 6) according to this embodiment, including activating the R/P circuit when an incoming call is sensed, are similar to steps 502, 504 of the preceding embodiment of the inventive method, the only evident difference being in that activation signal is passed to the R/P circuit 30 directly from the EC circuit 42 and not via the IC circuit 44 and the HC circuit 12.

Being activated, the R/P circuit will start in parallel to receive (in step 602) the reference signals RS from the reference sensor 50 and to monitor (in step 604) for the headset signal SI of the first type from the headset sensor 20, the signal SI corresponding to movements of the user's head in the YZ plane. In case it is determined in steps 606, 608 that no headset signal has been generated during the preselected first time interval TI1′ allowed for reaction of the user to the ringing tone or to other signal provided by the headset, the R/P circuit is deactivated in step 610, and the incoming call is “missed”.

On receiving the headset signal SI (as indicated by the YES branch of step 606), the R/P circuit performs, in step 612, a comparison of the headset signal SI and the reference signal RS. Such comparison is performed, for example, by subtracting the reference signal RS (adjusted as explained above) from the first type headset signal SI. In step 614 a check is performed, whether resulting difference signal DS exceeds a preselected differential threshold DT (a level of this threshold is also selected depending on a character and amplitudes of potential movements of the object (in this case the terminal 40) bearing the reference sensor relative the user's head bearing the headset 10).

If it is determined in step 614 that the difference signal DS is less than the differential threshold DT, this signal is ignored as non-relevant, i.e. as a signal resulting from a non-intentional movement of the head produced by some movement or acceleration of the vehicle, so that monitoring for a relevant headset signal is continued (as indicated by the NO branch of the block 614) until the expiration of the first time interval TI1′. In this case the R/P circuit is deactivated in step 610 and the incoming call is “missed”.

When the user makes an intentional nod during the first time interval TI1′, the difference signal first becomes equal to the differential threshold DT and then exceeds it. Starting from this moment, the check is conducted (in steps 616-620), whether the detected movement of the head corresponds to a nod or to some other, non-relevant movement (for example, the user may simply bend his head or his whole body). More specifically, in step 616 comparison of the headset and reference signals is resumed for the second time interval TI2′ selected such that TI2′ is substantially less than TI1′ (for example, TI2′ may correspond to ⅓-⅔ of TI1′). If during the whole time interval TI2′ the difference signal continues to exceed the threshold DT (as determined in steps 618, 620), the earlier detected movement of the user's head is again interpreted as non-intentional (non-relevant to controlling the acceptance of the incoming call), so that, as indicated by the YES branch of the block 620, the R/P circuit is deactivated and the incoming call is “missed”.

Determination (in step 618) that the difference signal DR became lower than the threshold DT before the second time interval TI2 is over means that the user is indeed making a nod. On finding that DR became less than DT, the R/P circuit generates, in step 622, control data associated with the command “Accept call” and sends said data directly to the terminal control unit 46. On receiving control data sent by the R/P circuit, the terminal control unit generates (in step 624) an appropriate command and sends it to the EC circuit, so that the call is accepted. In parallel, the terminal control unit 46 activates a two-way audio transmission between the terminal 40 and the headset 10, so that the user may talk with a caller. Simultaneously, the control unit instructs the R/P circuit to monitor (in step 626) for signals of the second type from the headset sensor 20, these signals of the second type corresponding to movements of the user's head in the XY plane. Processing the second type signals SII, together with reference signals of the same type is quite similar to the described processing of the first type signals, so it will not described in detail here. When a relevant turn of the user's head is detected by the R/P circuit in step 628, it sends, in step 630, appropriate control data to the terminal control unit 46, which unit generates, in step 632, a command to end the call, just as if a specific “end call” button on the headset was pressed, and deactivate (in step 610) the R/P circuit.

It will be evident from the above description of the presented exemplary embodiments of the invention that with the use of even a single tri-axis accelerometer (or an inclinometer, a gyroscope or another appropriate sensor capable to detect movements and/or accelerations in three orthogonal planes, a large number of different head movements may be detected individually or in various combinations. This means that a large number of commands may be generated in an easy and (if desirable) in a completely hands-free manner using the above-described inventive method and system. As was explained above, to improve reliability of differentiating relevant (intentional) head movements from accidental, non-intentional ones, one or more reference sensors may be additionally employed.

While the invention has been described with references to certain embodiments, it will be understood by those skilled in the art that various changes may be made and equivalents may be substituted without departing from the scope of the invention. In addition, many modifications may be made to adapt a particular situation or an application to the teachings of the invention without departing from its scope. Various software tools may be employed in processing the headset signals in order to reliably differentiate such signals from noise generated by the sensors due to unintended movements of the user's head. The above-described commands generated by the sound terminal were presented only as examples of a wide range of commands which may be generated by various movements of the user's head or by combinations of such movements. The Bluetooth communication link connecting the Bluetooth mobile phone with the Bluetooth headset was also mentioned as an example only and other type(s) of wired or wireless communication (i.e. an Ultra Low Power (ULP) Bluetooth or Infrared (IR) link) may be employed. Instead of the voice communication system, some other appropriate sound system (i.e. a system comprising a media player and/or another sound reproducing device) or any appropriate combination of the voice communication system and the sound reproducing device(s) may be used. Therefore, it is intended that the invention not be limited to the particular embodiments disclosed but will include all embodiments falling, within the scope of the appended claims.

What is claimed is:

1. A headset for use with a separate sound terminal, the headset comprising:
a headset communication circuit for receiving audio information from said terminal;
sound reproducing means for reproducing audio information received by the headset communication circuit; and
a control circuit adapted for controlling the headset and for generating and sending to the sound terminal control data, said control data enabling said terminal to execute one or more commands from a preselected set of commands,
wherein the control circuit further comprises:
at least one headset sensor mechanically connected to said headset for forming at least one type of headset signals, said at least one type of headset signals characterizing at least one of parameters selected from a group including a position of the headset, an orientation of the headset, and a movement of the headset; and
a receiving/processing circuit for receiving and processing said at least one type of headset signals to generate said control data.

2. The headset according to claim 1, wherein said at least one headset sensor is adapted for forming at least one type of headset signals indicating an attainment of a preselected threshold by at least one of said parameters.

3. The headset according to claim 1 comprising at least one reference sensor adapted for mounting to an object moveable in relation to the headset and for forming at least one type of reference signals, said at least one type of reference signals characterizing at least one of parameters selected from a group including a position of said object, an orientation of said object, and a movement of said object, wherein:
said at least one type of reference signals is of the same type as said at least one type of headset signals; and
said receiving/processing circuit is additionally adapted for receiving/processing said at least one type of reference signals to generate said control data on the base of results of processing at least one type of signals and said at least one type of said reference signals.

4. A sound terminal comprising:
an internal communication circuit for sending to a separate headset associated with said terminal audio information received from at least one external device or generated by said terminal; and
a control circuit for controlling said terminal by generating and executing commands from a preselected set of commands;
wherein said control circuit is adapted for:
receiving at least one type of headset signals formed by at least one headset sensor mechanically connected to said headset, said at least one type of headset signals characterizing at least one of parameters selected from a group including a position of the headset, an orientation of the headset, and a movement of the headset; and
processing said at least one type of headset signals with generating one or more commands from the preselected set of commands.

5. The sound terminal according to claim 4, wherein the control circuit is further adapted for:
receiving at least one type of reference signals formed by at least one reference sensor adapted for mounting to an object moveable in relation to the headset and for forming at least one type of reference signals, said at least one type of reference signals characterizing at least one of parameters selected from a group including a position of said object, an orientation of said object, and a movement of said object;
processing said at least one type of reference signals; and
generating commands from results of processing said at least one type of headset signals and at least one type of reference signals.

6. The sound terminal according to claim 4, wherein:
said terminal is a voice communication terminal further comprises an external communication circuit for receiving audio information from at least one external communication device associated with said terminal and for transmitting to said at least one external communication device audio information received by said terminal from said headset; and
the internal communication circuit of said terminal is further adapted for sending to said headset audio information received from said at least one external communication device and for receiving audio information from said headset.

7. The sound terminal according to claim 6, wherein said terminal is a mobile phone.

8. The sound terminal according to claim 4, wherein said terminal is a device selected from a media player and a radio receiver and a gaming console.

9. A sound system comprising:
a headset comprising:
a headset communication circuit for receiving audio information from a separate sound terminal;
sound reproducing means for reproducing audio information received by the headset communication circuit; and
at least one headset sensor mechanically connected to said headset for forming at least one type of headset signals, said at least one type of headset signals characterizing at least one of parameters selected from a group including a position of the headset, an orientation of the headset, and a movement of the headset;
a receiving/processing circuit for receiving and processing said at least one type of headset signals with generating control data; and
a sound terminal distantly located from said headset, said terminal comprising:
an internal communication circuit for sending to said headset audio information received from at least one external communication device or generated by said terminal; and
a control circuit for controlling said terminal by generating and executing commands from a preselected set of commands;
wherein said control circuit is adapted for receiving said control data with generating, in response, one or more commands from the preselected set of commands.

10. The sound system according to claim 9, wherein said receiving/processing circuit is included in the control circuit of the sound terminal.

11. The sound system according to claim 9, wherein:
said sound system is a voice communication system;
said headset communication circuit is further adapted for generating and sending audio information to said terminal;
said terminal is a voice communication terminal further comprises an external communication circuit for receiving audio information from at least one external communication device associated with said terminal and for transmitting to said at least one external communication device audio information received by said terminal from said headset; and
the internal communication circuit of said terminal is further adapted for sending to said headset audio information received from said at least one external communication device and for receiving audio information from said headset.

12. The sound system according to claim 9, wherein said terminal is a device selected from a media player and a radio receiver and a gaming console.

13. The sound system according to claim 12, wherein the preselected set of commands includes such commands as: “pausing music”; “increasing sound volume” and “decreasing sound volume”.

14. The sound system according to claim 9, wherein said receiving/processing circuit is included in the headset.

15. The sound system according to claim 9 further comprising at least one reference sensor adapted for mounting to an object moveable in relation to the headset and for forming at least one type of reference signals, said at least one type of reference signals said at least one type of reference signals being of the same type as said at least one type of headset signals and characterizing at least one of parameters selected from a group including a position of said object, an orientation of said object, and a movement of said object; wherein said receiving/processing circuit is further adapted for receiving and processing said at least one type of reference signals and for generating control data from results of processing said at least one type of headset signals and at least one type of reference signals.

16. The sound system according to claim 15, wherein said at least one reference sensor is mechanically connected with said terminal.

17. The sound system according to claim 9, wherein each of the headset communication circuit and the internal communication circuit is formed as a Bluetooth link.

18. A method of controlling a voice communication session via a voice communication terminal by a user employing a headset connected with said terminal, the method comprising the steps of:
(a) receiving, from at least one headset sensor mechanically connected with said headset, at least one type of headset signals characterizing at least one of parameters selected from a group including a position of the headset, an orientation of the headset, and a movement of the headset;
(b) processing said at least one type of headset signals with transforming said headset signals into control data adapted for generating by said terminal, on receiving said control data, one or more commands from a preselected set of commands controlling said voice communication session;
(c) receiving by said terminal said control data; and
(d) generating by said terminal, on receiving said control data, one or more commands from said preselected set of commands.

19. The method according to claim 18, wherein the steps (a) and (b) are performed by a receiving/processing circuit included in the headset.

20. The method according to claim 18, wherein the steps (a) and (b) are performed by a receiving/processing circuit included in the voice communication terminal.

21. The method according to claim 18, wherein the preselected set of commands includes such commands as: “answer call”, “reject call”, “end call” and “redial last number”.

22. The method according to claim 18, wherein the step (a) includes receiving different types of headset signals, each type of said signals characterizing one type of the headset movements produced by associated types of movements of the user's head, said movements selected from a group including turns and inclinations of the user's head.

23. The method according to claim 18, wherein the step (a) includes receiving at least one type of headset signals characterizing vibrations of the headset movements produced by tapping on the headset by the user's hand or finger.

24. The method according to claim 18, wherein the step (b) comprises conducting a comparison of at least one type of said headset signals with a preselected threshold associated with said at least one type of said headset signals and, if at least one of said headset signals exceeds said threshold, blocking said at least one signal from further processing.

25. The method according to claim 18, wherein the step (a) further comprises receiving, from at least one reference sensor mechanically connected with an object moveable in relation to the headset, at least one type of reference signals, said at least one type of reference signals characterizing at least one of parameters selected from a group including a position, an orientation and/or a movement of said moveable object; and wherein said at least one type of reference signals is used in transforming said at least one headset signal into said control data at the step (b).
